(19) United States
(12) Patent Application Publication
(10) Pub. No.: US 2007/0211368 A1
(43) Pub. Date: Sep. 13, 2007

(54) Magnetic recording medium, magnetic recording apparatus, and servo demodulation circuit

(75) Inventors: Motomichi Shibano, Kawasaki (JP); Haruhiko Izumi, Kawasaki (JP)

Correspondence Address: Patrick G. Burns, Esq.;GREER, BURNS, CRAIN, LTD., Suite 2500, 300 South Wacker Dr., Chicago, IL, 60606, US

(73) Assignee: FUJITSU LIMITED

(21) Appl. No.: 11/476,509

(22) Filed: Jun. 28, 2006

(30) Foreign Application Priority Data
Mar. 9, 2006 (JP) 2006-063992

(51) Int. Cl. G11B 21/02; G11B 5/09; G11B 5/596; G11B 20/08

(52) U.S. Cl. 360/75; 360/77.02; 360/29; 360/48

(57) ABSTRACT

A signal is recorded on a magnetic recording medium by changing a magnetized state of a magnetic member. The magnetic recording medium includes a plurality of servo signal areas in which servo signals for controlling a position of a reproducing head are recorded with different recording frequencies in parallel to a predetermined track so that the servo signals are read by the reproducing head when the reproducing head reproduces the servo signals along the predetermined track.

### BACKGROUND OF THE PRESENT INVENTION

1. Field of the Present Invention

The present invention relates to a technology for performing precise track positioning of a magnetic head that records or reproduces data and reducing fluctuation and imbalance of a position of the magnetic head.

2. Description of the Related Art

In recent years, as the performance level of calculators has improved, the requirements for the performance level of magnetic disc apparatuses in terms of data transfer rates and storage capacities have become more demanding. To increase the storage capacities, it is necessary to increase the data recording density by forming magnetic domain arrays on a magnetic recording medium more finely, with the signal magnetic field generated from the magnetic head. As a method for achieving this result, a vertical magnetic recording method, which is different from a conventional in-plane magnetic recording method, is drawing attention.

Also, another method to increase the data recording density per unit area by physically making the track pitch in the radial direction of a magnetic recording medium smaller is also considered. It is confirmed that, with the vertical magnetic recording method, a recording density equal to or higher than 100 Gbit/inch² can be achieved.

When the track pitch is small, however, data is written to an adjacent track due to a magnetic field leakage from a lateral face of the magnetic head, and a crosstalk occurs when the data is reproduced.

To cope with this situation, another magnetic recording method is disclosed. According to this method, by making the width of the reproducing head smaller than the width of the track, the reproducing head is prevented from deviating from the track even if the position of the reproducing head changes (see, for example, Japanese Patent Application Laid-Open No. S59-168905).

According to the conventional techniques, however, the reproducing head needs to be made smaller as the track pitch is made smaller. One problem is that it becomes more difficult to manufacture the reproducing head as the size of the reproducing head becomes smaller.

On the other hand, when the size of a reproducing head is fixed to a certain level, it becomes necessary to determine the track position of the reproducing head with high accuracy and to exercise control so that fluctuations and imbalance in the position of the reproducing head are diminished. Another problem is that it is difficult to do so.

FIG. 14 is a drawing for explaining the problems with the conventional techniques. As shown in FIG. 14, when the width of a reproducing head 1 is sufficiently small with respect to the track width, the determination of the track position does not require a very high degree of precision. On the contrary, when the width of the reproducing head 1 is almost the same as the track width, the reproducing head 1 is positioned out of the track unless the track position is determined with high accuracy, and thus a cross talk occurs.

For this reason, it is getting to be an important issue how precisely the track position of a magnetic head used for recording and reproducing data can be determined and also how the fluctuations and imbalance in the position of the magnetic head can be diminished.

### SUMMARY OF THE PRESENT INVENTION

It is an object of the present invention to at least partially solve the problems in the conventional technology.

A magnetic recording medium according to one aspect of the present invention, on which a signal is recorded by changing a magnetized state of a magnetic member, includes a plurality of servo signal areas in which servo signals for controlling a position of a reproducing head are recorded with different recording frequencies in parallel to a predetermined track so that the servo signals are read by the reproducing head when the reproducing head reproduces the servo signals along the predetermined track.

A magnetic recording apparatus according to another aspect of the present invention records a signal on a magnetic recording medium by changing a magnetized state of a magnetic member. The magnetic recording apparatus includes a reproducing head that reads a plurality of servo signals for controlling a position of the reproducing head; and a control unit that controls a position of the reproducing head based on an amplitude ratio of frequency components obtained by separating the servo signal read by the reproducing head into the frequency components. The magnetic recording medium includes a plurality of servo signal areas in which the servo signals are recorded with different recording frequencies in parallel to a predetermined track so that the servo signals are read by the reproducing head when the reproducing head reproduces the servo signals along the predetermined track.

A magnetic recording apparatus according to still another aspect of the present invention records a signal on a magnetic recording medium by changing a magnetized state of a magnetic member. The magnetic recording apparatus includes a reproducing head that reads a plurality of first servo signals and second servo signals for controlling a position of the reproducing head; a reference-value setting unit that, when the second servo signals are read by the reproducing head, separates the second servo signals into frequency components, and sets a feature amount of the separated frequency components as a reference value; and a control unit that controls a position of the reproducing head based on an amplitude ratio of frequency components obtained by separating the first servo signals read by the reproducing head into frequency components. The control unit controls the position of the reproducing head based on the reference value set by the reference-value setting unit. The magnetic recording medium includes a plurality of servo signal areas in which the first servo signals are recorded with different recording frequencies in parallel to a predetermined track so that the first servo signals are read by the reproducing head when the reproducing head reproduces the first servo signals along the predetermined track. The predetermined track includes areas in which the second servo signals are recorded at recording frequencies equal to those of the first servo signals recorded in the servo signal areas.

A servo demodulation circuit according to still another aspect of the present invention includes an input unit that inputs a reproduction signal from a medium on which a plurality of servo signals are recorded with a first recording frequency and a second recording frequency, respectively; a first calculating unit that calculates amplitude of a first recording frequency component in the reproduction signal; and a second calculating unit that calculates amplitude of a second recording frequency component in the reproduction signal.

The above and other objects, features, advantages and technical and industrial significance of this invention will be better understood by reading the following detailed description of presently preferred embodiments of the present invention, when considered in connection with the accompanying drawings.

### BRIEF DESCRIPTION OF THE DRAWINGS

FIG. 1 is a drawing for explaining a magnetic recording medium according to a first embodiment of the present invention;

FIG. 2 is a drawing of a high-recording-frequency area and a low-recording-frequency area provided on a magnetic recording medium;

FIG. 3 is a drawing of an example of a servo signal read by a reproducing head;

FIG. 4 is a drawing of an example of a frequency distribution of a servo signal extracted with a Fourier transform;

FIG. 5 is a drawing of the functional configuration of a magnetic recording apparatus according to the first embodiment;

FIG. 6 is a drawing of detailed functional configuration of a control unit shown in FIG. 5;

FIG. 7 is a drawing of an example of a magnetic recording medium on which servo signal patterns are formed so as to alternate on a central track and adjacent tracks;

FIG. 8 is a drawing of high-recording-frequency areas and low-recording-frequency areas provided on a discrete track recording medium;

FIG. 9 is a drawing for explaining a magnetic recording medium according to a second embodiment of the present invention;

FIG. 10 is a drawing of detailed functional configuration of a control unit included in the magnetic recording/reproducing apparatus according to the second embodiment;

FIG. 11 is a flowchart of the processing procedure in the head position control processing according to the second embodiment;

FIG. 12 is a drawing of a magnetic recording medium from which the high-recording-frequency servo signal patterns and the low-recording-frequency servo signal patterns are read alternately;

FIG. 13 is a drawing for explaining the high-recording-frequency servo signal patterns and the low-recording-frequency servo signal patterns recorded on a patterned medium; and

FIG. 14 is a drawing for explaining problems with conventional techniques.

### DETAILED DESCRIPTION OF THE PREFERRED EMBODIMENTS

Exemplary embodiments of the present invention will be explained in detail below with reference to the accompanying drawings. In the following description, the magnetic recording medium is a recording medium that has signals recorded thereon by changing the magnetized state of a magnetic member, and examples of such a magnetic recording medium include a hard disc and a flexible disc.

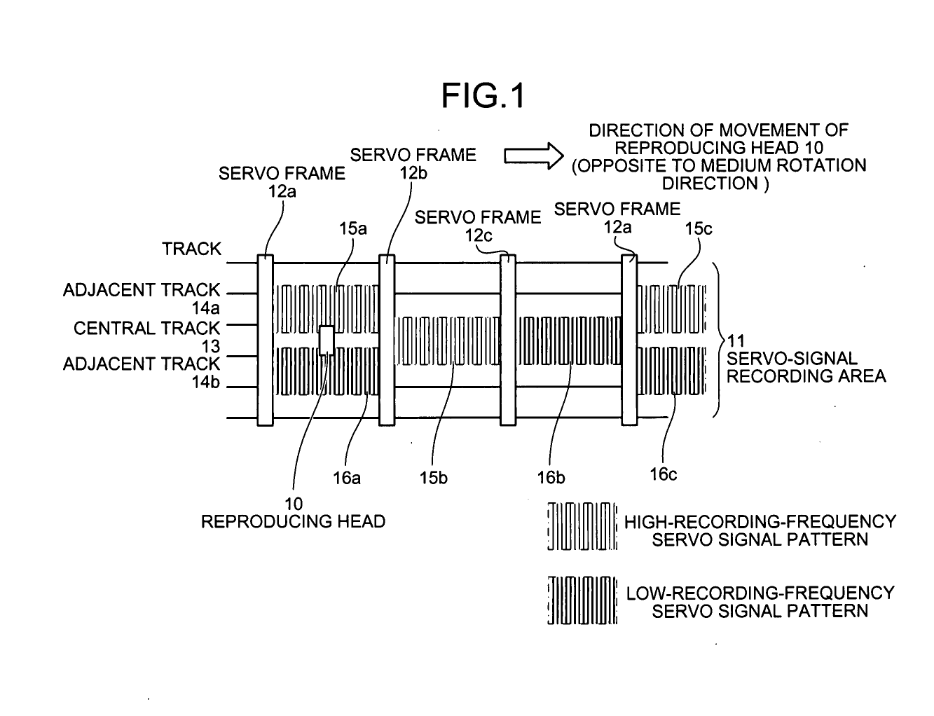

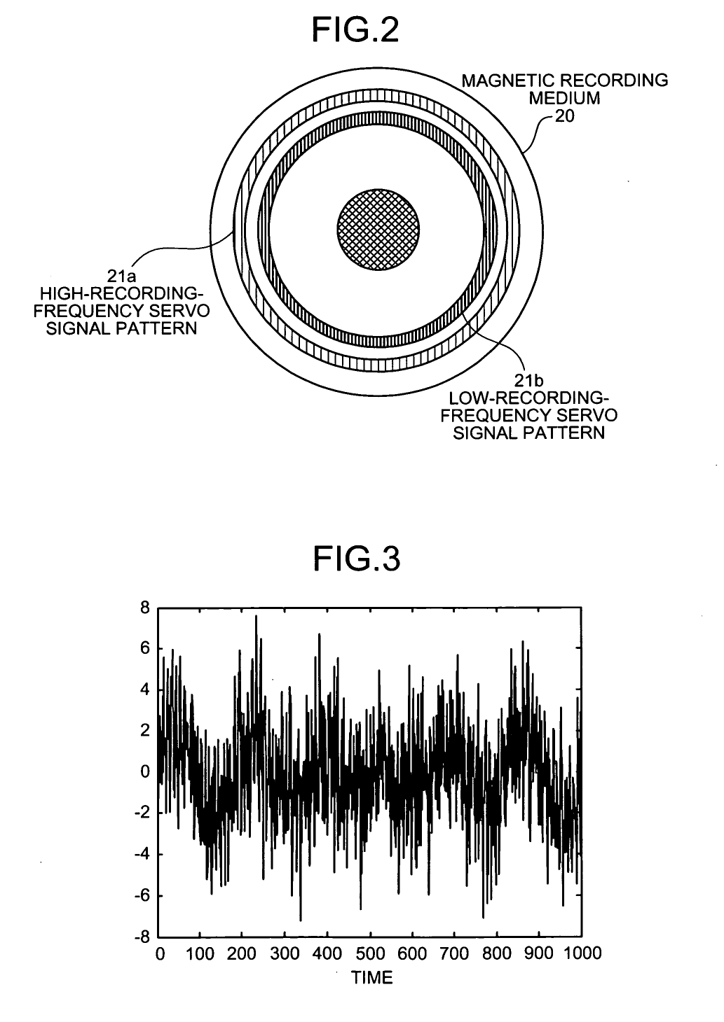

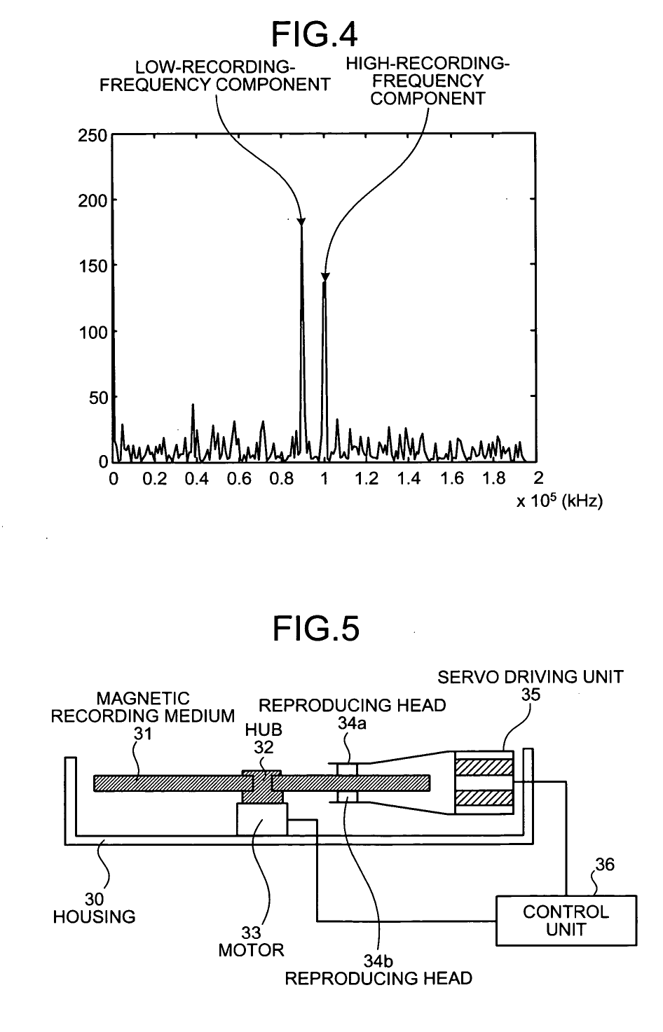

FIG. 1 is a drawing for explaining a magnetic recording medium according to a first embodiment of the present invention. FIG. 2 is a drawing of a high-recording-frequency area and a low-recording-frequency area provided on a magnetic recording medium. FIG. 3 is a drawing of an example of a servo signal read by a reproducing head. FIG. 4 is a drawing of an example of a frequency distribution of a servo signal extracted with a Fourier transform.

As shown in FIG. 1, the magnetic recording medium has, in parts of the tracks thereon, servo-signal recording areas 11 in which servo signals used for determining the track position of a magnetic head are recorded. In other areas (not shown) of the magnetic recording medium besides the servo-signal recording areas 11, user data is recorded.

Provided in the servo-signal recording areas 11 are servo frames 12a to 12d, a central track 13, and two adjacent tracks 14a and 14b that are positioned adjacent to the central track 13. The servo frames 12a to 12d are areas in which control information used for determining the track position of the magnetic head and address information of each sector are stored.

On the adjacent tracks 14a and 14b that are positioned adjacent to the central track, servo signals that have mutually different recording frequencies are recorded. For example, one servo signal is recorded at a high frequency (e.g. 100 megahertz or 200 megahertz) on the adjacent track 14a and another servo signal is recorded at a low frequency (e.g. 10 megahertz or 100 megahertz) on the adjacent track 14b. Thus, high-recording-frequency servo signal patterns 15a and 15c and low-recording-frequency servo signal patterns 16a and 16c are formed, respectively.

The servo signals recorded on the adjacent tracks 14a and 14b are read by a reproducing head 10. These servo signal patterns are recorded with offsets while having the central track 13 in the middle.

This arrangement with the offsets is made so that, when the servo signals are recorded on the magnetic recording medium, it is possible to prevent the areas for the servo signals recorded first from becoming small due to an overlap between the patterns of servo signals recorded first and the patterns of servo signals recorded second.

These servo signal patterns may be formed in each of the sectors on the adjacent tracks 14a and 14b, as shown in FIG. 1. Alternatively, the servo signal patterns may be formed as a high-recording-frequency servo signal pattern 21a that is recorded at a high frequency and a low-recording-frequency servo signal pattern 21b that is recorded at a low frequency, using the entire circumference of the track on the magnetic recording medium 20, as shown in FIG. 2.

The servo signals that are recorded at the high frequency and the low frequency on the magnetic recording medium as described above are read by the reproducing head 10. A Fast Fourier Transform (FFT) is applied to the servo signals read by the reproducing head 10. Thus, a frequency distribution as shown in FIG. 4 is detected.

As shown in FIG. 4, a low-recording-frequency component and a high-recording-frequency component that correspond to the servo signals recorded on the adjacent tracks 14a and 14b are detected as a result of the fast Fourier transform.

The processing for determining the track position of a magnetic head is performed by detecting the amplitudes of the low-recording-frequency component and the high-recording-frequency component that are shown in FIG. 4. The track position of the reproducing head 10 is controlled so that the amplitude ratio of the low-recording-frequency component and the high-recording-frequency component becomes the amplitude ratio obtained when the reproducing head 10 is positioned at the center of the central track 13 shown in FIG. 1.

If the position of the reproducing head 10 deviates from above the central track 13 toward the adjacent track 14a or the adjacent track 14b, the amplitude of the frequency component that corresponds to the servo signal recorded on the adjacent track 14a or the adjacent track 14b toward which the reproducing head 10 has deviated becomes larger. In this situation, the reproducing head 10 is controlled so that it is moved to a position at which the amplitude of the frequency component becomes smaller.

When the difference in the amplitude ratios is within a predetermined range, the control amount for correcting the deviation from the target position (i.e. the center of the central track 13) in the processing of determining the track position of the reproducing head 10 is recorded as a post code into the servo frames 12a to 12d.

When user data is recorded or reproduced, the reproducing head 10 reads the control amount recorded as the post code, and the deviation of a recording head (not shown) or the reproducing head 10 from the target position (the center of the track) is corrected based on the read control amount.

It should be noted that, to obtain information of the amplitude ratio at a time when the reproducing head 10 is positioned at the center of the central track 13 shown in FIG. 1, in some parts of the central track 13, each of a high-recording-frequency servo signal pattern 15b and a low-recording-frequency servo signal pattern 16b is recorded by itself.

When the servo signals that have been recorded as the high-recording-frequency servo signal pattern 15b and the low-recording-frequency servo signal pattern 16b are read by the reproducing head 10, and a fast Fourier transform is applied to the servo signals, a high-recording-frequency component and a low-recording-frequency component that correspond to the high-recording-frequency servo signal pattern 15b and the low-recording-frequency servo signal pattern 16b are detected.

Subsequently, the amplitude ratio of the high-recording-frequency component and the low-recording-frequency component that have been detected this way is compared with the amplitude ratio of the high-recording-frequency component and the low-recording-frequency component that correspond to the high-recording-frequency servo signal patterns 15a and 15c and the low-recording-frequency servo signal patterns 16a and 16c, so that the track position of the reproducing head 10 is controlled.

As shown in FIG. 2, when the high-recording-frequency servo signal pattern 15b and the low-recording-frequency servo signal pattern 16b are not formed on the central track 13, an amplitude ratio that is set based on an experiment conducted in advance or the like is compared with the amplitude ratio of a high-recording-frequency component and a low-recording-frequency component that are detected from the high-recording-frequency servo signal pattern 21a and the low-recording-frequency servo signal pattern 21b, so that the track position of the reproducing head 10 is controlled.

When the high-recording-frequency component and the low-recording-frequency component are extracted from the frequency distribution as shown in FIG. 4, the high-recording-frequency component and the low-recording-frequency component are extracted, using the frequencies of the high-recording-frequency component and the low-recording-frequency component that are detected based on the high-recording-frequency servo signal pattern 15b and the low-recording-frequency servo signal pattern 16b.

As explained above, it is possible to detect fluctuations and imbalance (the direction and the size of imbalance) in the position of the reproducing head 10 by detecting each of the high frequency component and the low frequency component of the servo signals recorded at the high recording frequency and the low recording frequency and calculating the amplitude ratio of the frequency components. Thus, it is possible to determine the track position of the magnetic head with high accuracy according to the information and to exercise control so that the fluctuations and the imbalance in the position of the magnetic head are diminished.

FIG. 5 is a drawing of the functional configuration of the magnetic recording apparatus according to the first embodiment. As shown in FIG. 5, the magnetic recording apparatus includes a housing 30, a magnetic recording medium 31, a hub 32, a motor 33, reproducing heads 34a and 34b, a servo driving unit 35, and a control unit 36.

The housing 30 is made of aluminum, and houses therein the magnetic recording medium 31, the hub 32, the motor 33, the reproducing heads 34a and 34b, and the servo driving unit 35. These elements are enclosed within the housing 30 and are secluded from the ambient air by a shielding member and a top plate (not shown) that are attached to the housing 30.

The magnetic recording medium 31 is a recording medium on which user data is recorded magnetically. The magnetic recording medium 31 has the servo-signal recording areas 11, as explained with reference to FIG. 1. The magnetic recording medium 31 is attached to the motor 33 via the hub 32 and rotates at a predetermined angle velocity.

The reproducing heads 34a and 34b are reproducing heads that read the data recorded on the magnetic recording medium 31. The magnetic recording apparatus further includes a recording head (not shown) that records data onto the magnetic recording medium 31.

The servo driving unit 35 loads and unloads the reproducing heads 34a and 34b (or the recording head) onto and from the magnetic recording medium 31 and performs a seek operation to move the reproducing heads 34a and 34b (or the recording head) to the inner circumference and the outer circumference of the magnetic recording medium 31.

The servo driving unit 35 includes a voice coil motor (VCM) and performs the seek operation by controlling the rotation of the slider on which the reproducing heads 34a and 34b (or the recording head) are mounted.

The control unit 36 gives instructions to the motor 33 and the servo driving unit 35 so as to control the operations of the motor 33 and the servo driving unit 35.

The control unit 36 controls the motor 33 so that the magnetic recording medium 31 rotates at a predetermined rotation speed and also stops and starts rotating. The control unit 36 also controls the servo driving unit 35 so that the reproducing heads 34a and 34b (or the recording head) are loaded onto and unloaded from the magnetic recording medium 31, and also the reproducing heads 34a and 34b (or the recording head) are moved to the inner circumference and the outer circumference of the magnetic recording medium 31.

In addition, the control unit 36 exercises control so that the servo signals are read from the magnetic recording medium 31 as explained with reference to FIG. 1, and the positions of the reproducing heads 34a and 34b (or the recording medium) are determined based on the read servo signals.

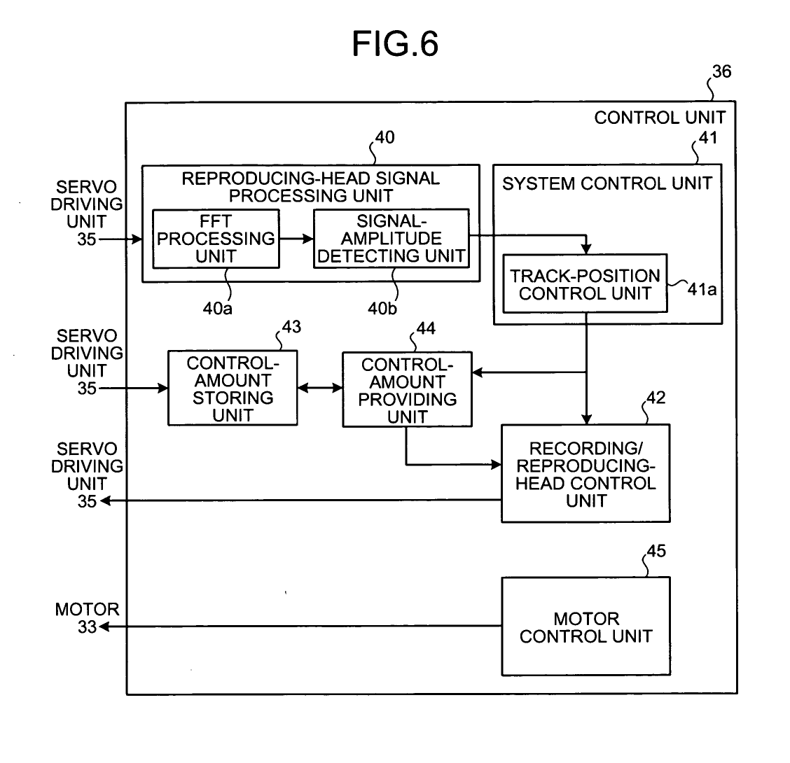

FIG. 6 is a drawing of detailed functional configuration of the control unit 36 shown in FIG. 5. As shown in FIG. 6, the control unit 36 includes a reproducing-head signal processing unit 40, a system control unit 41, a recording/reproducing-head control unit 42, a control-amount storing unit 43, a control-amount providing unit 44, and a motor control unit 45.

The reproducing-head signal processing unit 40 a reproduction signal of the servo signals recorded on the magnetic recording medium 31 from the servo driving unit 35 and detects the amplitudes of the low-recording-frequency component and the high-recording-frequency component from the frequency distribution of the reproduction signal as shown in FIG. 4.

The reproducing-head signal processing unit 40 includes an FFT processing unit 40a and a signal-amplitude detecting unit 40b. The FFT processing unit 40a applies a fast Fourier transform to the reproduction signal of the servo signals and detects the frequency distribution as shown in FIG. 4.

The signal-amplitude detecting unit 40b detects the amplitude ratio between the low-recording-frequency component and the high-recording-frequency component from the frequency distribution detected by the FFT processing unit 40a. In this situation, the signal-amplitude detecting unit 40b sets the frequencies of the low-recording-frequency component and the high-recording-frequency component to be detected, based on the frequencies of the low-recording-frequency component and the high-recording-frequency component that are obtained from the reproduction signal of the high-recording-frequency servo signal pattern 15b and the low-recording-frequency servo signal pattern 16b formed on the central track 13, as explained with reference to FIG. 1.

The signal-amplitude detecting unit 40b also performs a processing of determining the amplitude ratio to be used as a reference and to be compared with the amplitude ratio of the detected low-recording-frequency component and high-recording-frequency component, based on the amplitude ratio of the low-recording-frequency component and the high-recording-frequency component obtained from the reproduction signal of the high-recording-frequency servo signal pattern 15b and the low-recording-frequency servo signal pattern 16b.

When having judged that the detected amplitude ratio is different from the reference amplitude ratio by a value equal to or larger than a predetermined value and that the positions of the reproducing heads 34a and 34b deviate from the center of the central track 13, the signal-amplitude detecting unit 40b outputs, to the system control unit 41, information of the amplitude correction amount to change the amplitude ratio back to the reference amplitude ratio.

The system control unit 41 generates a control signal for controlling the servo driving unit 35 and includes a track-position control unit 41a. The track-position control unit 41a receives the information of the amplitude correction amount output by the signal-amplitude detecting unit 40b, converts the correction amount into a control signal used for determining the track positions of the reproducing heads 34a and 34b, and outputs the control signal to the recording/reproducing-head control unit 42.

For example, when the positions of the reproducing heads 34a and 34b deviate from above the central track 13 toward the adjacent track 14a, the amplitude of the frequency component that corresponds to the servo signal recorded on the adjacent track 14a toward which the reproducing head positions have deviated becomes larger. The amplitude of the frequency component that corresponds to the servo signal recorded on the adjacent track 14b in the opposite direction becomes smaller.

In this situation, the signal-amplitude detecting unit 40b calculates the amplitude correction amount to make the amplitude smaller for the frequency component of which the amplitude has become larger, or the amplitude correction amount to make the amplitude larger for the frequency component of which the amplitude has become smaller, so that the amplitude ratio is maintained at the predetermined value, and the correction amount is output to the system control unit 41.

Having received the information of the correction amount, the track-position control unit 41a converts the correction amount information into information of a movement amount to move the reproducing heads 34a and 34b in the direction opposite to the direction in which the reproducing heads 34a and 34b have deviated and outputs the information of the movement amount to the recording/reproducing-head control unit 42.

The recording/reproducing-head control unit 42 receives the information of the movement amount for the reproducing heads 34a and 34b from the track-position control unit 41a and controls the servo driving unit 35 by sending the information to the servo driving-unit 35.

Also, the recording/reproducing-head control unit 42 receives the control information that is to be stored, as the post code, into the servo frames 12a to 12d on the magnetic recording medium as shown in FIG. 1, from the control-amount providing unit 44, sends the received control information to the servo driving unit 35, and has the servo frames 12a to 12d store therein the control information as the post code.

The control information is the information of the control amount for correcting the deviation of the reproducing heads 34a and 34b (or the recording head) from the target position (the center of the central track 13) in the track position determining process. The information of the control amount is read when user data is recorded onto the magnetic recording medium or when the user data recorded on the magnetic recording medium is read. The track positions of the reproducing heads 34a and 34b (or the recording head) are controlled based on the control amount information that has been read.

The control-amount storing unit 43 is a storing unit such as a memory that, when the control amount information stored as the post code is read at a time when user data is recorded or reproduced, stores therein the read control amount information.

The control-amount providing unit 44 performs a processing of converting the information of the movement amount for the reproducing heads 34a and 34b generated by the track-position control unit 41a into the control information stored, as the post code, into the servo frames 12a to 12d on the magnetic recording medium.

Also, when the control information stored as the post code is read from the servo frames 12a to 12d, the control-amount providing unit 44 converts the control information into the information of the movement amount by which the reproducing heads 34a and 34b (or the recording head) are moved and outputs the movement amount information to the recording/reproducing-head control unit 42.

Having received the movement amount information, the recording/reproducing-head control unit 42 exercises control for determining the track positions of the reproducing heads 34a and 34b (or the recording head) by sending the movement amount information to the servo driving unit 35.

The motor control unit 45 controls the motor 33 and performs the processing of making the magnetic recording medium 31 rotate at the predetermined rotation speed and also stop and start rotating.

To determine the track positions of the reproducing heads 34a and 34b (or the recording head) with high accuracy, it is necessary to make the degree of precision for the positions at which the servo signal patterns are recorded sufficiently higher than the servo precision degree of the reproducing heads 34a and 34b (or the recording head).

However, when a conventional servo track writer (STW) is used, imbalance in the position of the servo track writer itself affects the degree of precision for the positions of the servo signal patterns, and a problem arises where the degree of precision for the positions of the servo signal patterns is lowered.

To cope with this problem, in the present example, the servo signal patterns are formed using a magnetic duplicate method. According to the magnetic duplicate method in which a stamper is used, it is possible to make a deviation of the position of a servo signal pattern as small as a number of nanometers, even after the degree of precision in manufacture of a stamper and the degree of precision in the transfer process are taken into account.

According to the first embodiment, to enhance the quality of the servo signals, various types of arrangements are made to the servo signal patterns recorded on the magnetic recording medium. For example, as shown in FIG. 1, an arrangement is made so that the width of each of the servo signal patterns is larger than the width of each of the central track 13 and the adjacent tracks 14a and 14b. With this arrangement, the reproducing head 10 is able to detect the servo signals with a higher probability Also, an arrangement is made so that the effective width of the central track 13 is smaller than the width of the reproducing head 10. With this arrangement, a similar effect is achieved. To be more specific, as shown in FIG. 1, the effective width of the central track 13, which is sandwiched between the high-recording-frequency servo signal patterns 15a and 15c and the low-recording-frequency servo signal patterns 16a and 16c, is arranged to be smaller than the width (the effective value) of the reproducing head 10.

Another arrangement is made so that the central track 13 is in a demagnetized state where no signal patterns are recorded, and also the high-recording-frequency servo signal patterns 15a and 15c and the low-recording-frequency servo signal patterns 16a and 16c are recorded as being apart from one another on either side of the central track 13. With this arrangement, it is possible to prevent the areas of the servo signal patterns from becoming smaller due to being overwritten by another servo signal pattern.

For example, when the magnetic recording medium is an in-plane recording medium, it is desirable that the central track 13 is in the direct current erase (DC erase) state. When the magnetic recording medium is a vertical recording medium, it is desirable that the central track 13 is in the alternating current erase (AC erase) state.

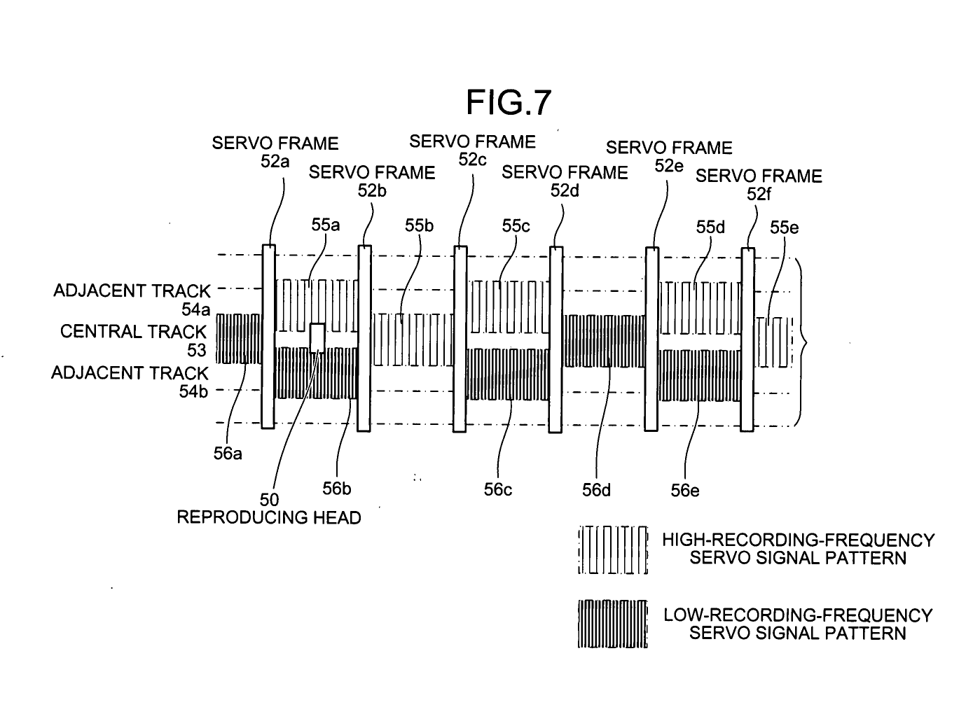

When a high-recording-frequency servo signal pattern and a low-recording-frequency servo signal pattern are provided using the entire circumference of the track, an arrangement is acceptable in which high-recording-frequency servo signal patterns 55a to 55e or low-recording-frequency servo signal patterns 56a to 56e are recorded so as to alternate on a central track 53 and adjacent tracks 54a and 54b, as shown in FIG. 7.

With this arrangement in which the servo signal patterns are recorded so as to alternate on the central track 53 and the adjacent tracks 54a and 54b, it is possible to set the reference values of the amplitude ratio and the frequency in each of the areas on the magnetic recording medium, as explained with reference to FIG. 1. Even if there is unevenness in the sensitivity level for detecting the servo signals on the track, it is possible to determine the track positions of the reproducing heads 34a and 34b (or the recording head) with high accuracy.

When the magnetic recording medium is divided into a plurality of zones in a concentric fashion, an arrangement is acceptable in which a high-recording-frequency servo signal pattern and a low-recording-frequency servo signal pattern are recorded for each group of a number of zones, and the track positions of the reproducing heads 34a and 34b (or the recording head) are determined based on the recorded high-recording-frequency servo signal pattern and low-recording-frequency servo signal pattern.

When the control amount that has been recorded as the post code in servo frames 50a to 50f varies by a value equal to or larger than a predetermined value among a plurality of zones in which the high-recording-frequency servo signal pattern and the low-recording-frequency servo signal pattern are recorded, the control-amount providing unit 44 interpolates the control amount according to the positions of the reproducing heads 34a and 34b in the radial direction and calculates the movement amounts by which the reproducing heads 34a and 34b are moved based on the interpolated control amount. The recording/reproducing-head control unit 42 then outputs the information of the movement amounts to the servo driving unit 35, and the track positions are determined according to the positions of the reproducing heads 34a and 34b (or the recording head) in the radial direction.

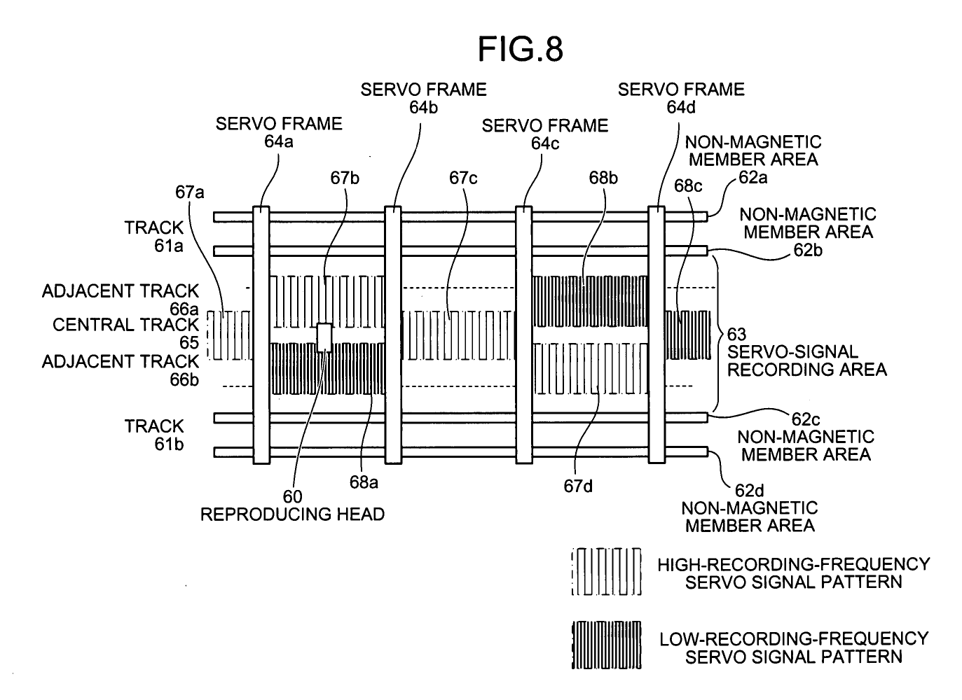

In addition, it is possible to apply the present invention not only when the magnetic recording medium is a continuous film medium as described above but also when the magnetic recording medium is a discrete track recording medium. FIG. 8 is a drawing of high-recording-frequency areas and low-recording-frequency areas provided on a discrete track recording medium.

As shown in FIG. 8, on the discrete track recording medium, non-magnetic member areas 62a to 62d (guard bands (GB)) that are made of a non-magnetic member are provided on either side of tracks 61a and 61b on which data is recorded.

With this arrangement, when the recording head records some data on the tracks 61a and 61b, it is possible to prevent the other tracks from having noise recorded thereon. Also, when a reproducing head 60 reproduces the data recorded on the tracks 61a and 61b, it is possible to prevent a crosstalk from occurring, the crosstalk denoting a situation where the data recorded on the other tracks are read.

In a servo-signal recording area 63 in which servo signals are recorded, occurrence of crosstalk is allowed because no non-magnetic member areas are provided on a central track 65 and on the sides of adjacent tracks 66a and 66b. An arrangement is made so that the reproducing head 60 is able to read both of the high-recording-frequency servo signal patterns 67b and 67d and low-recording-frequency servo signal patterns 68a and 68b that are recorded so as to be parallel to the adjacent tracks 66a and 66b.

Examples of methods for manufacturing such a discrete track recording medium include a method by which a magnetic member film is generated while areas that correspond to the non-magnetic member areas 62a to 62d are excluded, and a method by which the non-magnetic member areas 62a to 62d are generated by physically changing the composition with an ion implantation.

Because these methods involve a nanoimprint process, a fine mask exposure step, or the like, the degree of precision in the process and the degree of precision with regard to positional deviation are better than the degree of precision in the position control of the reproducing head 60. Thus, it is considered that the effect of the manufacturing method of the discrete track recording medium exerted on the control of the position of the reproducing head 60 is small.

As explained above, according to the first embodiment, as shown in FIG. 1, the magnetic recording medium that has signals recorded thereon by changing the magnetized state of the magnetic member has areas in which the high-recording-frequency servo signal patterns 15a and 15c and the low-recording-frequency servo signal patterns 16a and 16c are recorded at mutually different recording frequencies so as to be parallel to the central track 13, so that the servo signals are read by the reproducing head 10 when the reproducing head 10 reproduces, along the predetermined track, the servo signals used for controlling the position of the reproducing head 10. Thus, it is possible to detect the fluctuations and the imbalance (the direction and the size of imbalance) in the position of the reproducing head that reproduces the signals by detecting the frequency components from the high-recording-frequency servo signal patterns 15a and 15c and the low-recording-frequency servo signal patterns 16a and 16c that are recorded at the mutually different recording frequencies, and comparing the amplitude ratios of the frequency components. Accordingly, it is possible to determine the track position with high accuracy and to exercise control so that the fluctuations and the imbalance in the position of the magnetic head are diminished.

Furthermore, according to the first embodiment, the areas of the high-recording-frequency servo signal patterns 15a and 15c and the low-recording-frequency servo signal patterns 16a and 16c are provided on either side of the central track 13 that is in a demagnetized state. Thus, when the high-recording-frequency servo signal patterns 15a and 15c and the low-recording-frequency servo signal patterns 16a and 16c are recorded at the mutually different recording frequencies, it is possible to prevent the areas for the servo signals recorded first from becoming small due to an overlap between the patterns of servo signals recorded first and the patterns of servo signals recorded second.

Moreover, according to the first embodiment, the width of the area of the central track 13 that is in a demagnetized state is smaller than the width of the reproducing head 10. Thus, the reproducing head is able to read, without fail, the high-recording-frequency servo signal patterns 15a and 15c and the low-recording-frequency servo signal patterns 16a and 16c that are recorded at the mutually different recording frequencies.

Furthermore, according to the first embodiment, within the sector of the magnetic recording medium, the areas of the high-recording-frequency servo signal patterns 15a and 15c and the low-recording-frequency servo signal patterns 16a and 16c are serially arranged in the circumferential direction of the sector. Thus, it is possible to detect the high-recording-frequency servo signal patterns 15a and 15c and the low-recording-frequency servo signal patterns 16a and 16c in the whole area of the sector, which is the smallest unit for recording data. Accordingly, it is possible to determine the track position in each of the sectors with high accuracy and to exercise control so that the fluctuations and the imbalance in the position of the magnetic head are diminished.

Moreover, according to the first embodiment, as shown in FIG. 2, the areas of the high-recording-frequency servo signal pattern 21a and the low-recording-frequency servo signal pattern 21b are provided using the entire circumference of the track on the magnetic recording medium. Accordingly, it is possible to detect the high-recording-frequency servo signal pattern 21a and the low-recording-frequency servo signal pattern 21b at any position in the circumferential direction of the rotating magnetic recording medium. Thus, it is possible to determine the track position with high accuracy at any position in the circumferential direction and to exercise control so that the fluctuations and the imbalance in the position of the magnetic head are diminished.

Furthermore, according to the first embodiment, as shown in FIG. 1, the central track 13 includes areas in which the high-recording-frequency servo signal pattern 15b and the low-recording-frequency servo signal pattern 16b are recorded at the recording frequencies equal to the mutual different recording frequencies at which the high-recording-frequency servo signal patterns 15a and 15c and the low-recording-frequency servo signal patterns 16a and 16c are recorded so as to be parallel to the central track 13. Accordingly, it is possible to enhance the degree of precision for determining the track position by using the feature amount (the amplitude or the frequency) of the frequency components detected from the high-recording-frequency servo signal pattern 15b and the low-recording-frequency servo signal pattern 16b as the reference value of the frequency components detected from the high-recording-frequency servo signal patterns 15a and 15c and the low-recording-frequency servo signal patterns 16a and 16c that are recorded at the mutually different recording frequencies.

Moreover, according to the first embodiment, as shown in FIG. 7, (a) the areas in which the high-recording-frequency servo signal patterns 55a, 55c, and 55d and the low-recording-frequency servo signal patterns 56b, 56c, and 56e are recorded at mutually different recording frequencies so as to be parallel to the central track 53 and (b) the areas that are included in the central track 53 and in which the high-recording-frequency servo signal patterns 55b and 55e and the low-recording-frequency servo signal patterns 56a and 56d are recorded at the recording frequencies equal to the recording frequencies at which the high-recording-frequency servo signal patterns 55a, 55c, and 55d and the low-recording-frequency servo signal patterns 56b, 56c, and 56e are recorded so as to be parallel to the central track 53 are provided so as to alternate in units of sectors. Accordingly, even if the reproduction characteristics of the signals vary from one area to another in the circumferential direction of the rotating magnetic recording medium, by using the feature amount (the amplitude or the frequency) of the frequency components detected from the high-recording-frequency servo signal patterns 55b and 55e and the low-recording-frequency servo signal patterns 56a and 56d as the reference values of the frequency components detected from the high-recording-frequency servo signal patterns 55a, 55c, and 55d and the low-recording-frequency servo signal patterns 56b, 56c, and 56e that are recorded at the mutually different recording frequencies, it is possible to enhance the degree of precision for determining the track position.

Furthermore, according to the first embodiment as shown in FIG. 8, the non-magnetic member areas 62a to 62d in which no signals can be recorded are further provided between the tracks on which the signals are recorded. The areas in which high-recording-frequency servo signal patterns 67a to 67d and the low-recording-frequency servo signal patterns 68a to 68c are recorded at mutually different recording frequencies so as to be parallel to the central track 65 are positioned so as to be sandwiched between the non-magnetic member areas 62b and 62c. Accordingly, even if the magnetic recording medium is, for example, of a discrete track type, it is possible to determine the track position with high accuracy and to exercise control so that the fluctuations and the imbalance in the position of the magnetic head are diminished.

Moreover, according to the first embodiment, the servo signal areas are generated using a magnetic duplicate method. Thus, it is possible to diminish deviations of the positions at which the servo signal areas are formed.

Furthermore, according to the first embodiment, the reproducing heads 34a and 34b read the high-recording-frequency servo signal patterns 15a and 15c and the low-recording-frequency servo signal patterns 16a and 16c that are recorded at mutually different frequencies so as to be parallel to the central track 13. Also, the control unit 36 controls the positions of the reproducing heads 34a and 34b, based on the amplitude ratio of the frequency components obtained by separating the high-recording-frequency servo signal patterns 15a and 15c and the low-recording-frequency servo signal patterns 16a and 16c that have been read by the reproducing heads 34a and 34b into the frequency components. Accordingly, it is possible to detect the fluctuations and the imbalance (the direction and the size of the imbalance) in the positions of the reproducing heads that reproduce the signals. Thus, it is possible to determine the track position with high accuracy and to exercise control so that the fluctuations and the imbalance in the positions of the magnetic heads are diminished.

Moreover, according to the first embodiment, the reproducing heads 34a and 34b read the high-recording-frequency servo signal patterns 15a and 15c and the low-recording-frequency servo signal patterns 16a and 16c that are recorded at mutually different frequencies so as to be parallel to the central track 13 and also the high-recording-frequency servo signal pattern 15b and the low-recording-frequency servo signal pattern 16b that are recorded on the central track 13. Also, when the high-recording-frequency servo signal pattern 15b and the low-recording-frequency servo signal pattern 16b have been read by the reproducing heads 34a and 34b, the control unit 36 separates the high-recording-frequency servo signal pattern 15b and the low-recording-frequency servo signal pattern 16b into frequency components and sets the feature amount (the amplitude or the frequency) of the separated frequency components as the reference value. Then, the control unit 36 controls the positions of the reproducing heads 34a and 34b, based on the amplitude ratio of the frequency components obtained by separating the high-recording-frequency servo signal patterns 15a and 15c and the low-recording-frequency servo signal patterns 16a and 16c that have been read by the reproducing heads 34a and 34b into the frequency components. Accordingly, the positions of the reproducing heads 34a and 34b are controlled based on the set reference value. Thus, it is possible to enhance the degree of precision for determining the track positions by using the feature amount of the frequency components detected from the high-recording-frequency servo signal pattern 15b and the low-recording-frequency servo signal pattern 16b as the reference values of the frequency components detected from the high-recording-frequency servo signal patterns 15a and 15c and the low-recording-frequency servo signal patterns 16a and 16c that are recorded at the mutually different recording frequencies.

In the description of the first embodiment, the example in which the track positions of the reproducing heads are determined by measuring the amplitudes of the servo signals is explained. When the distance between the reproducing head and the magnetic recording medium (i.e. the flying height of the reproducing head from the magnetic recording medium) changes, the results of the measuring of the servo signal amplitudes are affected. To be more specific, when the flying height of the reproducing head from the magnetic recording medium becomes large, the amplitudes of the servo signals tend to decrease rapidly. Thus, it becomes difficult to determine the track position. For this reason, in the description of a second embodiment of the present invention, an example in which the flying height of the reproducing head is controlled in addition to the control for determining the track position of the reproducing head will be explained.

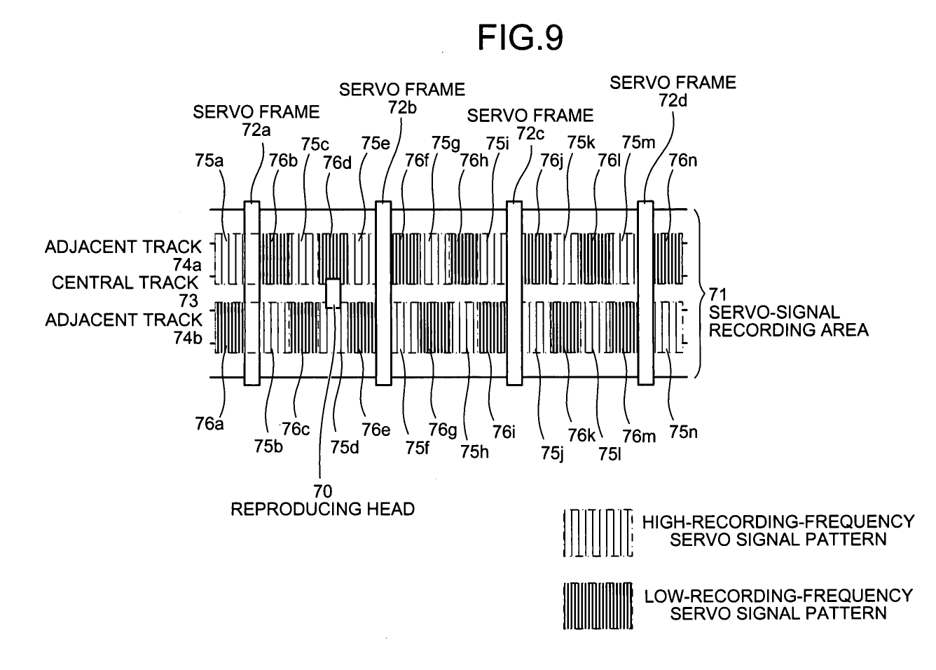

FIG. 9 is a drawing for explaining a magnetic recording medium according to the second embodiment. As shown in FIG. 9, the magnetic recording medium includes a servo-signal recording area 71 in which servo signals used for determining the position of a reproducing head 70 with respect to the tracks and also for controlling the flying height of the reproducing head 70 are recorded. In other areas of the magnetic recording medium besides the servo-signal recording area 71, user data is recorded.

Provided in the servo-signal recording area 71 are servo frames 72a to 72d, a central track 73, and two adjacent tracks 74a and 74b that are positioned adjacent to the central track 73. The servo frames 72a to 72d are areas in which servo signals used for determining the position of the reproducing head 70 with respect to the tracks and address information of each sector are stored.

On the adjacent tracks 74a and 74b that are positioned adjacent to the central track, servo signals that have mutually different recording frequencies are recorded so as to alternate. To be more specific, on the adjacent tracks 74a and 74b, high-recording-frequency servo signal patterns 75a to 75n that are recorded at a high frequency (e.g. 100 megahertz or 200 megahertz) and low-recording-frequency servo signal patterns 76a to 76n that are recorded at a low frequency (e.g. 10 megahertz or 100 megahertz) are recorded so as to alternate.

In other parts of the magnetic recording medium, like the high-recording-frequency servo signal pattern 15b and the low-recording-frequency servo signal pattern 16b that are shown FIG. 1, a high-recording-frequency servo signal pattern and a low-recording-frequency servo signal pattern (not shown) are recorded on the central track 73 using the entire circumference of the track for the purpose of setting the reference values of amplitude and frequency of the servo signals.

In the processing of determining the track position according to the second embodiment, just like in the first embodiment, at first, servo signals are detected from the high-recording-frequency servo signal patterns 75a to 75n and the low-recording-frequency servo signal patterns 76a to 76n with a fast Fourier transform. Then, the amplitude ratio of the low-recording-frequency component and the high-recording-frequency component in the detected servo signals is calculated, and the processing for determining the track position of the reproducing head 70 is controlled according to the amplitude ratio.

After the track position determining processing is performed, the processing for controlling the flying height of the reproducing head 70 is performed. To be more specific, a low-recording-frequency component and a high-recording-frequency component are detected from the high-recording-frequency servo signal pattern and the low-recording-frequency servo signal pattern that are recorded on the central track 73 for the purpose of setting the reference values of amplitude and frequency of the servo signals. The average values of the amplitudes and the frequencies of the low-recording-frequency component and the high-recording-frequency component are calculated as reference values.

The calculated average value of the frequencies is used as the frequency to extract a high-recording-frequency component and a low-recording-frequency component, when the high-recording-frequency component and the low-recording-frequency component are extracted from a frequency distribution as shown in FIG. 4.

On the other hand, the calculated average value of the amplitudes of the high-recording-frequency component is compared with the amplitude of the high-recording-frequency component detected from the high-recording-frequency servo signal patterns 75a to 75n. When the amplitude of the high-recording-frequency component is smaller than the average value by a value equal to or larger than a predetermined value, it is judged that the reproducing head 70 is glided too high above the magnetic recording medium. Thus, the reproducing head 70 is controlled so that the flying height becomes smaller.

Also, the calculated average value of the amplitudes of the low-recording-frequency component is compared with the amplitude of the low-recording-frequency component detected from the low-recording-frequency servo signal patterns 76a to 76n. When the amplitude of the low-recording-frequency component is larger than the average value by a value equal to or larger than a predetermined value, it is judged that there is a possibility that the reproducing head 70 may come in contact with the magnetic recording medium. Thus, the reproducing head 70 is controlled so that the flying height becomes larger.

As shown in FIG. 9, it is possible to measure the low-recording-frequency component and the high-recording-frequency component alternately within the sector by using the magnetic recording medium on which a plurality of patterns of the high-recording-frequency servo signal patterns 75a to 75n and the low-recording-frequency servo signal patterns 76a to 76n are recorded within the sector so as to alternate. Accordingly, it is possible to promptly detect fluctuations in the amplitude ratio of the frequency components. Thus, it is possible to exercise control, in a stable manner, for determining the track position and for the flying height of the reproducing head.

It should be noted that, in this example, the magnetic recording medium as shown in FIG. 9 is used; however, when the amplitude ratio does not fluctuate drastically, it is also acceptable to use the magnetic recording medium as shown in FIG. 1 on which a high-recording-frequency servo signal pattern and a low-recording-frequency servo signal pattern are recorded in each sector.

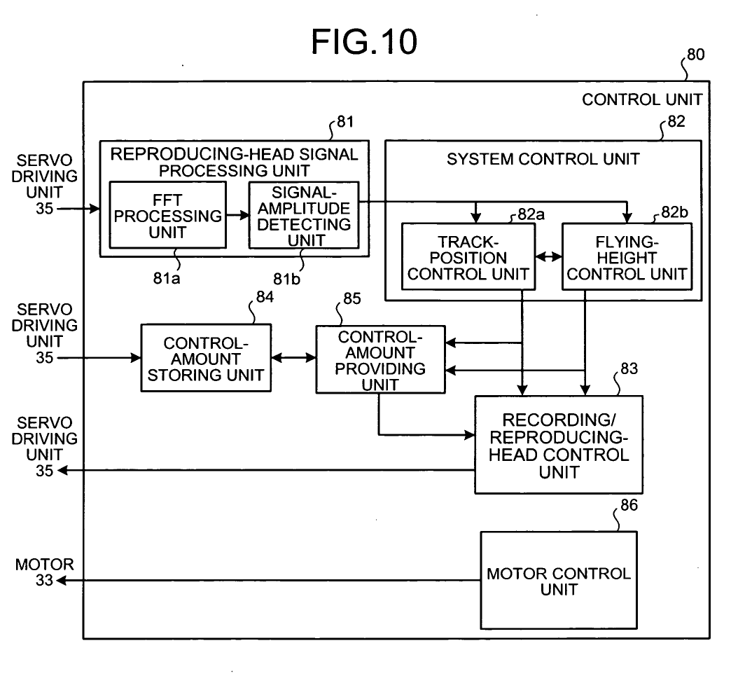

FIG. 10 is a drawing of detailed functional configuration of a control unit 80 included in the magnetic recording/reproducing apparatus according to the second embodiment. The functional configuration of the magnetic recording/reproducing apparatus other than the control unit 80 is the same as the one shown in FIG. 5; therefore, explanation thereof will be omitted, and the same reference characters as those in FIG. 5 will be used.

As shown in FIG. 10, the control unit 80 includes a reproducing-head signal processing unit 81, a system control unit 82, a recording/reproducing-head control unit 83, a control-amount storing unit 84, a control-amount providing unit 85, and a motor control unit 86.

The reproducing-head signal processing unit 81 corresponds to the reproducing-head signal processing unit 40 shown in FIG. 6 and has an equivalent function. To be more specific, the reproducing-head signal processing unit 81 receives a reproduction signal of the servo signals recorded on the magnetic recording medium 31 from the servo driving unit 35 and detects the amplitudes of the low-recording-frequency component and the high-recording-frequency component from a frequency distribution of the reproduction signal as shown in FIG. 4.

The reproducing-head signal processing unit 81 includes an FFT processing unit 81a and a signal-amplitude detecting unit 81b. The FFT processing unit 81a applies a fast Fourier transform to the reproduction signal of the servo signals and detects the frequency distribution as shown in FIG. 4.

The signal-amplitude detecting unit 81b detects the amplitude ratio of the low-recording-frequency component and the high-recording-frequency component from the frequency distribution detected by the FFT processing unit 81a. Further, when having judged that the detected amplitude ratio is different from the reference amplitude ratio and that the position of the reproducing head 70 deviates from the center of the central track 73, the signal-amplitude detecting unit 81b outputs, to the system control unit 82, information of the amplitude correction amount to change the amplitude ratio back to the reference amplitude ratio.

In addition, the signal-amplitude detecting unit 81b detects a low-recording-frequency component and a high-recording-frequency component from the high-recording-frequency servo signal pattern and the low-recording-frequency servo signal pattern that are recorded on the central track 73 using the entire circumference of the track for the purpose of setting the reference values of amplitude and frequency of the servo signals, and then calculates the average values of amplitudes and frequencies for the low-recording-frequency component and the high-recording-frequency component.

Also, the signal-amplitude detecting unit 81b compares the amplitude of the high-recording-frequency component detected from the high-recording-frequency servo signal patterns 75a to 75n with the average value of amplitudes of the high-recording-frequency component. When the amplitude of the high-recording-frequency component is smaller than the average value of amplitudes of the high-recording-frequency component by a value equal to or larger than a predetermined value, the signal-amplitude detecting unit 81b judges that the reproducing head 70 is floated too high above the magnetic recording medium, calculates an amplitude correction amount to make the amplitude of the high-recording-frequency component equal to the average value of amplitudes, and outputs the calculated correction amount to the system control unit 82.

On the other hand, when the amplitude of the low-recording-frequency component is larger than the average value of amplitudes of the low-recording-frequency component by a value equal to or larger than a predetermined value, the signal-amplitude detecting unit 81b judges that there is a possibility that the reproducing head 70 may come in contact with the magnetic recording medium, calculates an amplitude correction amount to make the amplitude of the low-recording-frequency component equal to the average value of amplitudes, and outputs the calculated correction amount to the system control unit 82.

The system control unit 82 generates control information for controlling the servo driving unit 35 and includes a track-position control unit 82a and a flying-height control unit 82b. The track-position control unit 82a corresponds to the track-position control unit 41a shown in FIG. 6 and has an equivalent function. To be more specific, the track-position control unit 82a receives the information of the amplitude correction amount output by the signal-amplitude detecting unit 81b, converts the correction amount into a control signal for determining the track position of the reproducing head 70, and outputs the converted control signal to the recording/reproducing-head control unit 83.

The flying height control unit 82b obtains the information of the amplitude correction amount for controlling the flying height of the reproducing head 70 from the signal-amplitude detecting unit 81b, converts the correction amount information into information of a movement amount to make the height of the reproducing head 70 higher or lower, and outputs the movement amount information to the recording/reproducing-head control unit 83.

The recording/reproducing-head control unit 83 receives the control information for determining the track position of, and for controlling the flying height of the reproducing head 70 from the track-position control unit 82a and the flying height control unit 82b and controls the servo driving unit 35 by sending the control information to the servo driving unit 35.

Also, the recording/reproducing-head control unit 83 receives control information to be stored as a post code into the servo frames 72a to 72d on the magnetic recording medium as shown in FIG. 9 from the control-amount providing unit 85, sends the received control information to the servo driving unit 35, and has the servo frames 72a to 72d store therein the received control information as the post code.

The control information is the information of the control amounts for correcting the deviation of the reproducing head 70 (or the recording head) from the target position (the center of the central track 73) in the track position determining process and for correcting the deviation from the target height above the magnetic recording medium in the flying height controlling process.

The information of the control amounts is read when user data is recorded onto the magnetic recording medium or when the user data recorded on the magnetic recording medium is read. The track position and the flying height of the reproducing head 70 (or the recording head) are controlled based on the control amount information that has been read.

The control-amount storing unit 84 is a storing unit such as a memory that, when the control information that is recorded using the entire circumference of the track and is stored as the post code is read at a time when user data is recorded or reproduced, stores therein the read control information.

The control-amount providing unit 85 performs a processing of converting the information of the movement amount of the reproducing head 70 generated by the track-position control unit 82a and the flying height control unit 82b into the control information that is stored, as the post code, into the servo frames 72a to 72d on the magnetic recording medium.

Also, when the control information stored as the post code is read from the servo frames 72a to 72d, the control-amount providing unit 85 converts the control information into the information of the movement amount by which the reproducing head 70 (or the recording head) is moved and outputs the movement amount information to the recording/reproducing-head control unit 83.

Having received the control information, the recording/reproducing-head control unit 83 exercises control for determining the track position and the flying height of the reproducing head 70 (or the recording head) by sending the control information to the servo driving unit 35.

The motor control unit 86 controls the motor 33 and performs the processing of making the magnetic recording medium rotate at the predetermined rotation speed and also stop and start rotating.

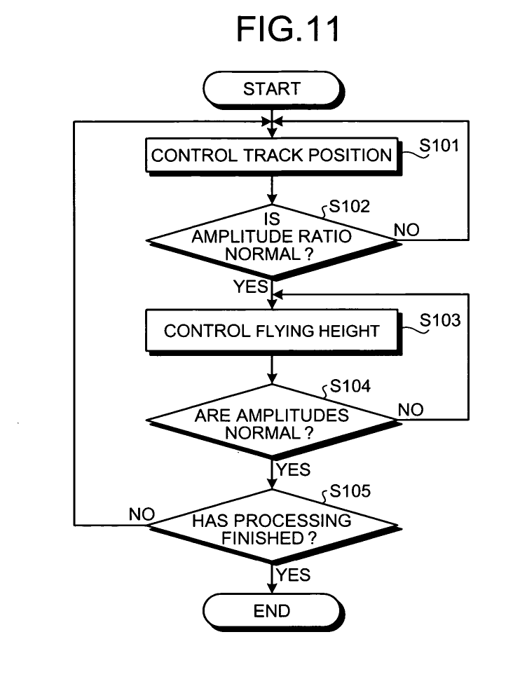

FIG. 11 is a flowchart of the processing procedure in the head position control processing according to the second embodiment.

As shown in FIG. 11, at first, the control unit 80 included in the magnetic recording apparatus controls the track position of the reproducing head 70 based on the amplitude ratio of the high-recording-frequency component and the low-recording-frequency component of the servo signals detected from the high-recording-frequency servo signal patterns 75a to 75n and the low-recording-frequency servo signal patterns 76a to 76n (step S101). The control unit 80 then checks if the amplitude ratio of the detected high-recording-frequency component and low-recording-frequency component is normal (step S102).

The control unit 80 checks if the amplitude ratio is normal by comparing the amplitude ratio of the low-recording-frequency component and the high-recording-frequency component detected from the high-recording-frequency servo signal pattern and the low-recording-frequency servo signal pattern that are recorded for the purpose of setting the reference values of amplitude and frequency of the servo signals with the amplitude ratio of the high-recording-frequency component and the low-recording-frequency component of the servo signals detected from the high-recording-frequency servo signal patterns 75a to 75n and the low-recording-frequency servo signal patterns 76a to 76n.

When the amplitude ratio is not normal (step S102: No), the procedure moves to step S101, and the control unit 80 performs the track position controlling process once again. When the amplitude ratio is normal (step S102: Yes), the control unit 80 controls the flying height of the reproducing head 70, based on the amplitudes of the high-recording-frequency component and the low-recording-frequency component of the servo signals detected from the high-recording-frequency servo signal patterns 75a to 75n and the low-recording-frequency servo signal patterns 76a to 76n (step S103).

Subsequently, the control unit 80 checks if the amplitudes of the detected high-recording-frequency component and low-recording-frequency component are normal (step S104). The control unit 80 checks if the amplitudes are normal by comparing the amplitudes of the low-recording-frequency component and the high-recording-frequency component detected from the high-recording-frequency servo signal pattern and the low-recording-frequency servo signal pattern that are recorded for the purpose of setting the reference values of amplitude and frequency of the servo signals with the amplitudes of the high-recording-frequency component and the low-recording-frequency component of the servo signals detected from the high-recording-frequency servo signal patterns 75a to 75n and the low-recording-frequency servo signal patterns 76a to 76n.

When the amplitudes are not normal (step S104: No), the procedure advances to step S103, and the control unit 80 performs the flying height controlling process once again. When the amplitudes are normal (step S104: Yes), the control unit 80 judges if the head position control processing has finished (step S105). When the head position control processing has not finished (step S105: No), the procedure advances to step S101, and the processing thereafter is continued.

When the processing has finished (step S105: Yes), the head position control processing is completed. The processing is considered to have finished when the electric power of the magnetic recording apparatus is turned off or when the magnetic recording apparatus is put into a standby state.

In this example, the reproducing head 70 simultaneously reads the high-recording-frequency servo signal patterns 75a to 75n and the low-recording-frequency servo signal patterns 76a to 76n that are recorded so as to be parallel to the central track 73 and extracts the high-recording-frequency component and the low-recording-frequency component as shown in FIG. 4; however, because the load imposed on the control unit 80 when the signal processing such as the fast Fourier transform is performed is large, it is acceptable to perform the signal processing alternately by reading the high-recording-frequency servo signal patterns 75a to 75n and the low-recording-frequency servo signal patterns 76a to 76n alternately.

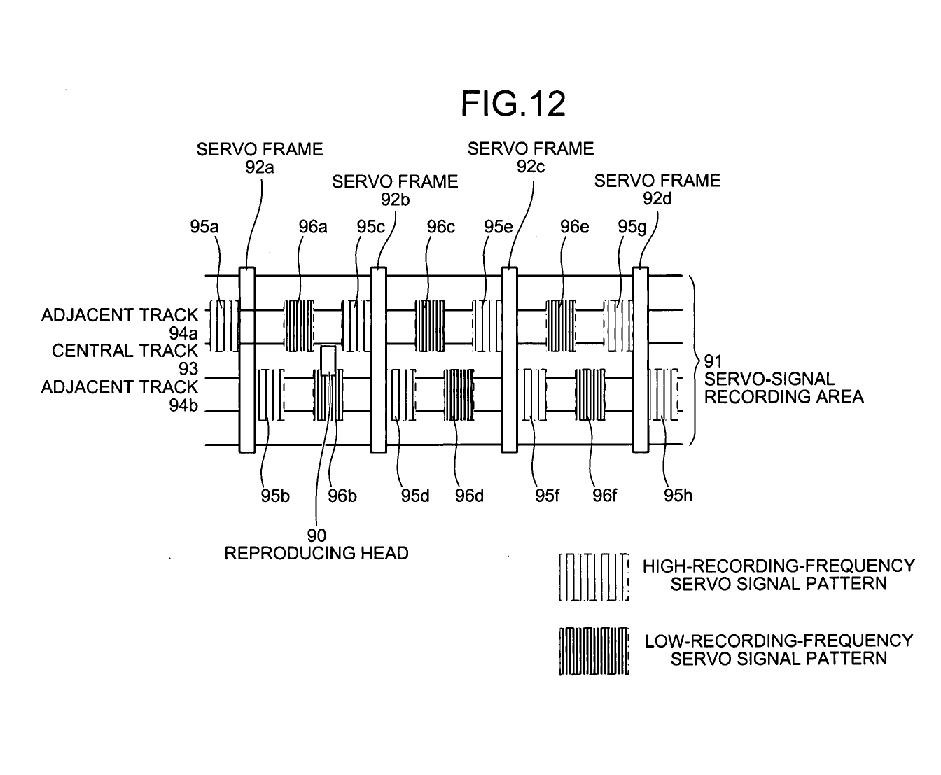

FIG. 12 is a drawing of a magnetic recording medium from which high-recording-frequency servo signal patterns 95a to 95h and low-recording-frequency servo signal patterns 96a to 96f are read alternately. As shown in FIG. 12, on this magnetic recording medium, the high-recording-frequency servo signal patterns 95a to 95h and the low-recording-frequency servo signal patterns 96a to 96f are recorded on adjacent tracks 94a and 94b so that the signal patterns are read by a reproducing head 90 one by one.

In this example, the reproducing-head signal processing unit 81 sequentially performs the processing of extracting the high-recording-frequency component shown in FIG. 4 from the high-recording-frequency servo signal patterns 95a to 95h and the processing of extracting the low-recording-frequency component from the low-recording-frequency servo signal patterns 96a to 96f.

Subsequently, the high-recording-frequency component and the low-recording-frequency component that have been extracted firstly are stored into a memory (not shown) provided in the reproducing-head signal processing unit 81 until a high-recording-frequency component and a low-recording-frequency component are extracted secondly. After the extraction of the high-recording-frequency component and the low-recording-frequency component is finished, the amplitude ratio of the components is calculated.

As explained above, according to the second embodiment, as shown in FIG. 9, a plurality of areas out of the areas in which the high-recording-frequency servo signal patterns 75a to 75n and the low-recording-frequency servo signal patterns 76a to 76n are recorded at the mutually different recording frequencies so as to be parallel to the central track 73 are provided within a sector in such a manner that the areas in which some of the high-recording-frequency servo signal patterns 75a to 75n and the low-recording-frequency servo signal patterns 76a to 76n are recorded at an equal recording frequency are not positioned next to each other. Accordingly, it is possible to determine the track position within the sector with high accuracy and also to efficiently control the flying height of the magnetic head from the magnetic recording medium.

Furthermore, according to the second embodiment, the control unit 80 included in the magnetic recording apparatus controls the flying height of the reproducing head from the magnetic recording medium, based on the amplitudes of the frequency components obtained by separating the high-recording-frequency servo signal patterns 75a to 75n and the low-recording-frequency servo signal patterns 76a to 76n that have been read by the reproducing head into the frequency components. Accordingly, it is possible to determine the track position within the sector with high accuracy and to efficiently control the flying height of the magnetic head from the magnetic recording medium.

The exemplary embodiments of the present invention have been explained so far; however, in addition to the exemplary embodiments described above, the present invention may be embodied in any other various embodiment examples within the scope of the technical ideas defined in the claims.

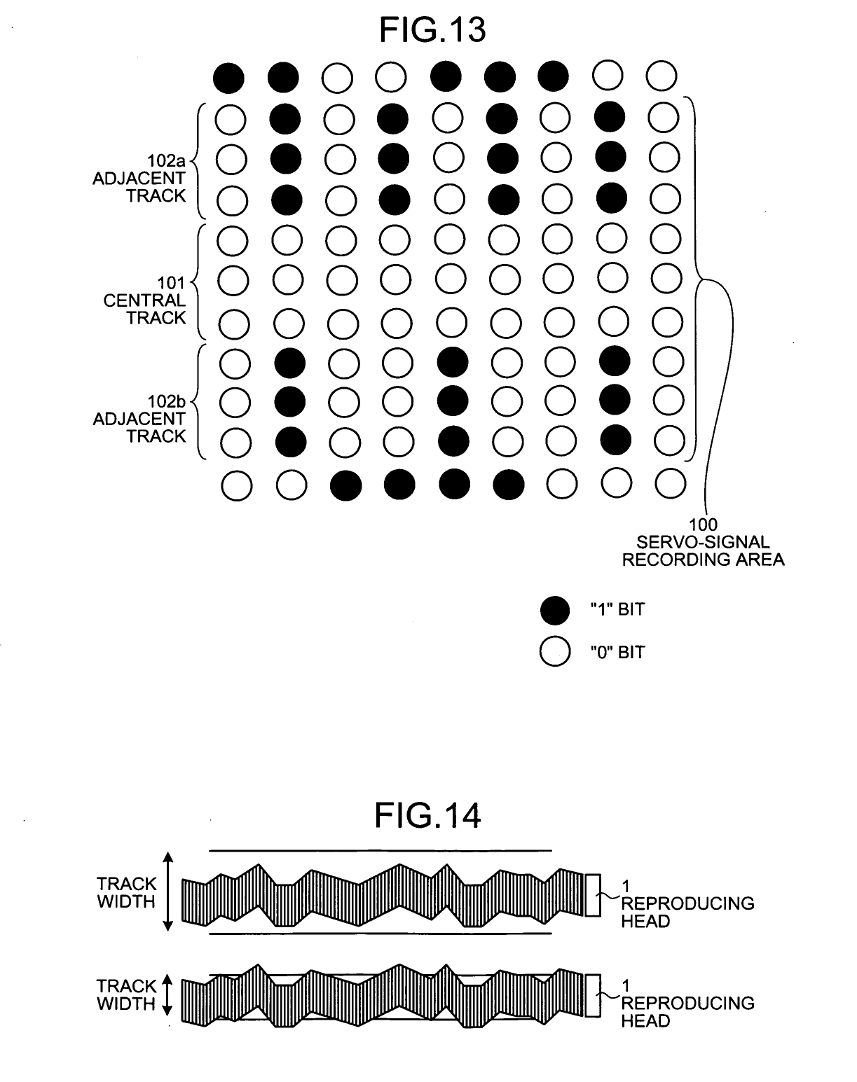

For example, the present invention may be applied to a patterned media, which is receiving attention as one of the next-generation recording media. FIG. 13 is a drawing for explaining the high-recording-frequency servo signal patterns and the low-recording-frequency servo signal patterns recorded on a patterned medium.

As shown in FIG. 13, the magnetic recording medium has a servo-signal recording area 100 that has servo signals recorded therein for controlling the position of a recording head that records data in predetermined areas of the patterned medium or the position of a reproducing head that reproduces the data. In other areas besides the servo-signal recording area 100, user data is recorded.

Provided in the servo-signal recording area 100 are a central track 101, and two adjacent tracks 102a and 102b that are positioned adjacent to the central track 101. Servo signals are recorded at mutually different recording frequencies on the adjacent tracks 102a and 102b that are positioned adjacent to the central track.

The difference in the recording frequencies corresponds to the difference in the distances between the “1” bits. In the example shown in FIG. 13, the “1” bits are recorded so that every other bit is a “1” bit on the adjacent track 102a, and one in every three bits is a “1” bit on the adjacent track 102b.

Using the method as explained in the first embodiment, the high-recording-frequency component and the low-recording-frequency component of the servo signals are detected from the high-recording-frequency servo signal pattern and the low-recording-frequency servo signal pattern that are recorded this way, and the amplitude ratios of the frequency components are compared. Thus, it is possible to determine the track position of the magnetic head with high accuracy.

Of the various types of processing explained in the exemplary embodiments, it is acceptable to manually perform part or all of any of the processing that has been explained as being performed automatically. Conversely, it is also acceptable to automatically perform, using a publicly-known method, part or all of any of the processing that has been explained as being performed manually.

In addition, the processing procedures, the controlling procedures, the specific names of the elements, and the information including various types of data and parameters that are presented in the description above and the drawings may be altered in any form of choice, unless it is particularly noted otherwise.

The constituent elements of the apparatuses shown in the drawings are based on functional concepts; therefore, the constituent elements do not necessarily have to be physically configured as shown in the drawings. In other words, the specific modes of disintegration and integration of the apparatuses are not limited to the ones shown in the drawings. It is acceptable to disintegrate or integrate the configuration of part or all of each of the apparatuses functionally or physically in any units of choice and according to various loads or the state of use.

Further, any part or all of the processing functions performed in each of the apparatuses may be realized by a central processing unit (CPU) and by a program that is analyzed and executed by the CPU or may be realized as hardware using wired logic.

According to an embodiment of the present invention, it is possible to detect fluctuations and imbalance (the direction and the size of imbalance) in the position of the magnetic head that reproduces the signals by detecting the frequency components of the plurality of servo signals that are recorded at the mutually different recording frequencies and comparing the amplitude ratios of the frequency components. Thus, an effect is achieved where it is possible to determine the track position with high accuracy and to exercise control so that the fluctuations and the imbalance in the position of the magnetic head are diminished.

Furthermore, according to an embodiment of the present invention, an effect is achieved where, when servo signals are recorded onto the magnetic recording medium at mutually different recording frequencies, it is possible to prevent the area for the servo signals recorded first from becoming small due to an overlap between the pattern of the servo signals recorded first and the pattern of servo signals recorded second.

Moreover, according to an embodiment of the present invention, an effect is achieved where it is possible for the reproducing head to read, without fail, the servo signals that are recorded at the mutually different recording frequencies.

Furthermore, according to an embodiment of the present invention, it is possible to detect the servo signals in the whole area of the sector, which is the smallest unit for recording data. Thus, it is possible to determine the track position in each of the sectors with high accuracy and to exercise control so that the fluctuations and the imbalance in the position of the magnetic head are diminished.

Moreover, according to an embodiment of the present invention, it is possible to detect the servo signals at any position in the circumferential direction of the rotating magnetic recording medium. Thus, it is possible to determine the track position with high accuracy at any position in the circumferential direction and to exercise control so that the fluctuations and the imbalance in the position of the magnetic head are diminished.

Furthermore, according to an embodiment of the present invention, the feature amount of the frequency components detected from the servo signals recorded on the predetermined track at the recording frequencies equal to the mutually different recording frequencies at which the servo signals are recorded is used as the reference value of the frequency components detected from the servo signals recorded at the mutually different recording frequencies. Thus, it is possible to enhance the accuracy for determining the track position.

Moreover, according to an embodiment of the present invention, even if the reproduction characteristics of the signals vary from one area to another in the circumferential direction of the rotating magnetic recording medium, the feature amount of the frequency components detected from the servo signals recorded at the recording frequencies equal to the mutually different recording frequencies at which the servo signals are recorded is used as the reference value of the frequency components detected from the servo signals recorded at the mutually different recording frequencies. Thus, an effect is achieved where it is possible to enhance the degree of precision for determining the track position.

Furthermore, according to an embodiment of the present invention, an effect is achieved where it is possible to promptly determine the track position in the sector and to efficiently control the flying height of the magnetic head from the magnetic recording medium.

Moreover, according to an embodiment of the present invention, an effect is achieved where, even if the magnetic recording medium is, for example, of a discrete track type, it is possible to determine the track position with high accuracy and to exercise control so that the fluctuations and the imbalance in the position of the magnetic head are diminished.

Furthermore, according to an embodiment of the present invention, an effect is achieved where it is possible to diminish deviations of the positions at which the servo signal areas are formed.

Moreover, according to an embodiment of the present invention, it is possible to detect the fluctuations and the imbalance (the direction and the size of the imbalance) in the position of the magnetic head that reproduces the signals. Thus, an effect is achieved where it is possible to determine the track position with high accuracy and to exercise control so that the fluctuations and the imbalance in the position of the magnetic head are diminished.

Furthermore, according to an embodiment of the present invention, the feature amount of the frequency components detected from the servo signals recorded at the recording frequencies equal to the mutually different recording frequencies at which the servo signals are recorded is used as the reference value of the frequency components detected from the servo signals recorded at the mutually different recording frequencies. Thus, an effect is achieved where it is possible to enhance the accuracy for determining the track position.

Moreover, according to an embodiment of the present invention, an effect is achieved where it is possible to determine the track position in the sector with high accuracy and to efficiently control the flying height of the magnetic head from the magnetic recording medium.

Furthermore, according to an embodiment of the present invention, it is possible to detect the fluctuations and the imbalance (the direction and the size of the imbalance) in the position of the magnetic head that reproduces the signals by calculating the amplitudes of the frequency components of the servo signals recorded at the mutually different recording frequencies. Thus, an effect is achieved where it is possible to determine the track position with high accuracy and to exercise control so that the fluctuations and the imbalance in the position of the magnetic head are diminished.

Moreover, according to an embodiment of the present invention, it is possible to detect the fluctuations and the imbalance (the direction and the size of the imbalance) in the position of the magnetic head that reproduces the signals by calculating the amplitude ratio of the frequency components of the servo signals recorded at the mutually different recording frequencies. Thus, an effect is achieved where it is possible to determine the track position with high accuracy and to exercise control so that the fluctuations and the imbalance in the position of the magnetic head are diminished.

Although the present invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A magnetic recording medium on which a signal is recorded by changing a magnetized state of a magnetic member, the magnetic recording medium comprising:
a plurality of servo signal areas in which servo signals for controlling a position of a reproducing head are recorded with different recording frequencies in parallel to a predetermined track so that the servo signals are read by the reproducing head when the reproducing head reproduces the servo signals along the predetermined track.

2. The magnetic recording medium according to claim 1, wherein
the servo signal areas are provided sandwiching a demagnetized area therebetween.

3. The magnetic recording medium according to claim 2, wherein
a width of the demagnetized area is smaller than a width of the reproducing head.

4. The magnetic recording medium according to claim 1, wherein
the servo signal areas are serially arranged in a circumferential direction of a sector of the magnetic recording medium.

5. The magnetic recording medium according to claim 1, wherein
the servo signal areas are provided over an entire circumference of a track on the magnetic recording medium.

6. The magnetic recording medium according to claim 1, wherein
the predetermined track includes areas in which servo signals are recorded at recording frequencies equal to those of the servo signals recorded in the servo signal areas.

7. The magnetic recording medium according to claim 6, wherein
the areas and the servo signal areas are provided alternately in units of sectors.

8. The magnetic recording medium according to claim 1, wherein
a plurality of the servo signal areas are provided in a sector in such a manner that areas in which the servo signals are recorded with an equal recording frequency are not positioned next to each other.

9. The magnetic recording medium according to claim 1, further comprising:
a plurality of non-magnetic member areas in which no signals can be recorded, the non-magnetic member areas being positioned between tracks on which signals are recorded, wherein
the servo signal areas are positioned to be sandwiched by the non-magnetic member areas.

10. The magnetic recording medium according to claim 1, wherein
the servo signal areas are created using a magnetic duplicate method.

11. A magnetic recording apparatus that records a signal on a magnetic recording medium by changing a magnetized state of a magnetic member, the magnetic recording apparatus comprising:
a reproducing head that reads a plurality of servo signals for controlling a position of the reproducing head; and
a control unit that controls a position of the reproducing head based on an amplitude ratio of frequency components obtained by separating the servo signal read by the reproducing head into the frequency components, wherein
the magnetic recording medium includes a plurality of servo signal areas in which the servo signals are recorded with different recording frequencies in parallel to a predetermined track so that the servo signals are read by the reproducing head when the reproducing head reproduces the servo signals along the predetermined track.

12. The magnetic recording apparatus according to claim 11, wherein
the control unit controls a flying height of the reproducing head based on amplitude of each of the frequency components.

13. A magnetic recording apparatus that records a signal on a magnetic recording medium by changing a magnetized state of a magnetic member, the magnetic recording apparatus comprising:
a reproducing head that reads a plurality of first servo signals and second servo signals for controlling a position of the reproducing head;
a reference-value setting unit that, when the second servo signals are read by the reproducing head, separates the second servo signals into frequency components, and sets a feature amount of the separated frequency components as a reference value; and
a control unit that controls a position of the reproducing head based on an amplitude ratio of frequency components obtained by separating the first servo signals read by the reproducing head into frequency components, wherein
the control unit controls the position of the reproducing head based on the reference value set by the reference-value setting unit,
the magnetic recording medium includes a plurality of servo signal areas in which the first servo signals are recorded with different recording frequencies in parallel to a predetermined track so that the first servo signals are read by the reproducing head when the reproducing head reproduces the first servo signals along the predetermined track, and
the predetermined track includes areas in which the second servo signals are recorded at recording frequencies equal to those of the first servo signals recorded in the servo signal areas.

14. The magnetic recording apparatus according to claim 13, wherein
the control unit controls a flying height of the reproducing head based on amplitude of each of the frequency components of the first servo signals.

15. A servo demodulation circuit comprising:
an input unit that inputs a reproduction signal from a medium on which a plurality of servo signals are recorded with a first recording frequency and a second recording frequency, respectively;
a first calculating unit that calculates amplitude of a first recording frequency component in the reproduction signal; and
a second calculating unit that calculates amplitude of a second recording frequency component in the reproduction signal.

16. The servo demodulation circuit according to claim 15, further comprising:
a ratio calculating unit that calculates a ratio of the amplitudes of the first recording frequency component and the second recording frequency component.
